(19) United States
(12) Patent Application Publication
(10) Pub. No.: US 2006/0255962 A1
(43) Pub. Date: Nov. 16, 2006

(54) Dedicated learn mode

(75) Inventor: Barry Caren, Beverly Hills, CA (US)

Correspondence Address: JAMES ALAN FRANKLIN, 7901 RAVENSWOOD RD, GRANBURY, TX, 76049, US

(73) Assignee: MAGNADYNE CORPORATION, COMPTON, CA (US)

(21) Appl. No.: 11/127,874

(22) Filed: May 12, 2005

(51) Int. Cl. G08C 19/00

(52) U.S. Cl. 340/825.69

(57) ABSTRACT

A learn switch coupled to a controller of a vehicle security system. The learn switch initiates the learn mode of the controller. In one embodiment the learn switch is placed in the same vicinity of the vehicle in the inventory of a lot. In another embodiment the learn switch is integral to the controller. And, in another embodiment the learn switch is placed within a the proximity of the controller. In all embodiments the learn switch places the controller in a learn mode and the learn switch is readily accessible by lot staff and the user.

### BACKGROUND

1. Field of the Invention

The present invention relates generally to OEM or aftermarket vehicle security and convenience systems that are pre-installed on a dealer lot and then sold to customers. Controllers of such systems are installed in the vehicles and they are responsive to a common authorization code which is typically transmitted by one or more dealer transmitters. This allows a single dealer transmitter to operate a number of lot vehicles.

2. Discussion of the Prior Art

It is common in the vehicle sales industry to “load” the inventory with a security and convenience system. This provides the dealer with an opportunity to sell a high margin item and capture additional value in conjunction with the sale of a vehicle. While the vehicle is in the inventory, the installed security system is programmed to one or more authorization codes that are assigned to transmitters carried by sales personnel on the lot. This allows a sales person to control a number of security systems on the lot with a single transmitter. This further eliminates the need of cycling to the key hub or the office to retrieve a dedicated transmitter to open or operate each of the vehicles. After the sale, however, the dealer replaces the common dealer authorization codes and/or programs the authorization code(s) of the transmitters sold with the vehicle.

A typical vehicle security system comprises a controller that senses inputs, receives and executes commands from authorized transmitters, sends control signals to interrupt the normal operation of the vehicle, or controls an audio and/or visual alarm signal, such as sounding of a siren and flashing lights. As an example, one or more of such commands originates from a manually actuatable “valet” switch that operates the controller alone or in combination with the ignition sense input. Typically a valet switch us installed out of view, so that a thief with a key or a thief that tampers with a steering column could not easily overcome the security system.

To program a new transmitter authorization code into a controller, the controller is placed in a learn mode. Initiation of the learn mode varies between manufacturers and various models. One typical way to initiate the learn mode is to turn on the ignition and then activate or cycle the valet switch a predetermined number of times or sequence within a period of time. The controller chirps or provides feedback to the user/programmer that it entered into learn mode and thereafter, the controller will learn authorization codes provided to it by a transmitter activated in its range.

Although the procedure is straight-forward to an experienced user, it is often puzzling to a novice. Such inexperienced users need to read the instructions and execute each step correctly. Second, they also need to locate the valet switch, which could be placed in a number of different, hidden or out of the view places, such as underneath the dash.

In a time sensitive sales environment, not knowing the operation of the security system or not knowing the location of the valet switch is frustrating and unproductive. It could interfere with or derail the sale of the security or convenience system. In other scenarios, buyers are compelled to return to the lot at a time when a qualified technician could program one or more customer transmitters into the system.

### SUMMARY

The disclosed device is a vehicle security/convenience system and in particular the controller having a dedicated learn switch that forces the controller into a learn mode. The learn switch is placed in one or more of the generally designated places or parts of the vehicles on the lot. In one embodiment the learn switch is placed in the glove compartment of each or most of the vehicles. In another embodiment, the learn switch is placed in the vicinity of the controller. In another embodiment, the learn switch is conspicuous to facilitate it's location by lot personnel. The conspicuous switch could be made selectively inconspicuous by removing a tag or a label, such as an orange sticker indicating its location. Yet in another embodiment the learn switch is connected to the controller or is in the vicinity of the controller that is in place of the factory starter or ignition cutoff switch.

### BRIEF DESCRIPTION OF THE DRAWINGS

FIG. 1 illustrates a block diagram of the transmitter and the controller.

### DETAILED DESCRIPTION

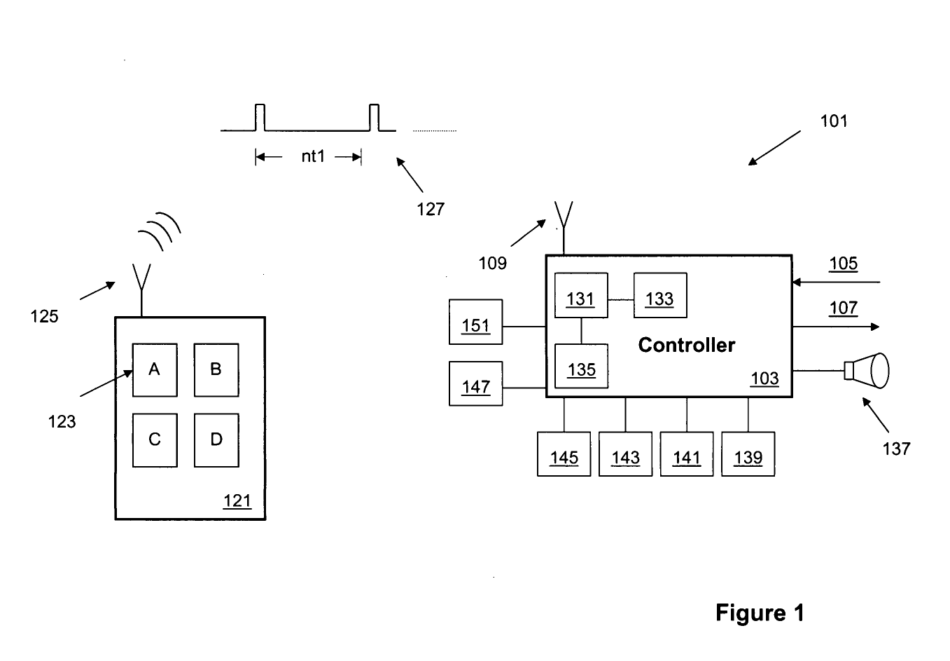

Shown in FIG. 1, is a representative security and/or vehicle convenience system (hereafter the “system”) 101. System 101 generally comprises one or more authorized transmitters 121 capable of transmitting command signals 127 to a controller 103. In response, controller 103 executes commands received from such authorized transmitters 121 or commands programmed into its structure. The structure of controller 103 consists, but is not limited to a memory 133; a logic execution device 131, such as a microprocessor; a decoder 135; one or more on-board and/or off-board relays 139; an on-board and/or off-board visual indicator 141, such as a light emitting diode; an antenna 109; an override switch 143, commonly referred to as a valet switch; and an acoustical transducer such as a siren 137. It is foreseeable that some or all of these components may be integrated into a single functioning unit, by consolidating discrete circuitry into one or more ICs (integrated circuits) or units.

The command signal 127 generally comprises an authorization code, which is initially programmed into controller 103. This provides access to and control of controller 103 via one or more authorized transmitters 121. Also part of the command signal 127 is a command code. The command code communicates to controller 103 the function that the authorized user wants executed. Examples of such functions, among others, are electrical signals via control lines or bus 107 to lock doors, to unlock doors, to flash lights, to open the trunk, lower or raise windows, and to sound siren 137. The commands are initiated by a user activating one or more switches 123 of authorized transmitter 121. Typically, command signal 127 is received by an antenna 109, decoded by a decoder 135 and the resulting digital string of signal 127 is then passed on to processor or logic and/or software 131 (hereafter collectively “logic circuitry 131 ”). Logic circuitry 131 then checks if the authorization code of command signal 127 matches a previously programmed authorization code normally resident in memory 133. If the received and stored authorized codes match, then controller 133 executes the command code of signal 127.

Outputs 107 control various functions in response to commands received from transmitter 121 or in response to conditions programmed into controller 103. Some of the exemplary functions are: 1) signal to lock and unlock the doors of a vehicle, either in response to transmitter 121 or automatically (passive arming) after a period of time; 2) flashing of lights, such as parking lights to provide a visual indication of executing a function; 3) audio feedback, such as the beeping of horn 137 or some other audio transducer 137 to provide an audio indication of executing a function; 4) starting of the vehicle; 5) controlling the trunk of the vehicle; 6) raising or lowering windows of the vehicle; 5) operational interrupt or cutoff via a relay 139, disabling a starting circuit or ignition circuit of the vehicle; and 6) any other function of the vehicle.

Input 105 provides controller 103 and its processor or logic unit 131 with control signals or conditional indication of one or more sensors 145 and/or 147 are placed about the vehicle. One example is a shock sensor 145 (shown as a dedicated input), indicating a shock or a physical disturbance in or about the vehicle. Shock sensor 145 and other sensors 147 or inputs could have either a dedicated input as diagrammatically shown in FIG. 1, or they can be electrically coupled to a data bus, providing digital or analog indication that the sensor was triggered. Another example of sensor 147 is a pin switch indicating that one or more of the doors are open. Yet another example is a signal from an infrared signal or magnetic field sensor. Visual indicator 141 is common place in security systems, providing a visual indication of the controller's status. As one example, the indicator 141 could be a light emitting diode, flashing at some duty cycle, indicating that the system is armed. Such indicators 141 are commonly placed in a conspicuous place on or about the dash of the vehicle to warn away the potential intruders.

As described in the U.S. utility patent application Ser. No. 11/020,911 (which is fully incorporated herein by reference and attached as Exhibit A and at the time of this disclosure assigned to common assignee, Magnadyne Corporation), system 101 could be configured to replace an operational relay of a vehicle, replacing such relay's functionality and adding additional functionality. In short, the replacement device integrates the functionality of the operational relay and further integrates controller 103 circuitry and functionality in similar space provided to the operational relay. In other embodiments, where controller 103 needs more space than is allowed by the OEM operational amplifier, system 101 will comprise a relay 139 with electrical connections to another physical device together comprising controller 103. Typically the replaced relay is operational to the continued operation or starting of the vehicle. In one example, the relay will not allow or will stop the starting of the vehicle. By replacing the functionality of such relay, system 101 duplicates its function and adds additional capabilities. Such replacement allows efficient installation.

Yet in another embodiment, as described more fully in the U.S. utility patent application Ser. No. 11/020,911, system 101 places relay 139 in electrical series with the vehicle's operational relay. Such configuration allows the OEM system to function as intended, and in the event the aftermarket security system 101 fails, it will not affect the operation of the OEM system and will not disable the operation of the vehicle by virtue of such failure.

In one embodiment the system employs a switch 143, commonly referred to as a “valet”switch. Switch 143 is inconspicuously mounted by the installer in the vehicle and its location is provided to the authorized user. Switch 143 has a number of functions, one of which is to disarm controller 103 when the user does not have an authorized transmitter 123 to disarm the vehicle, the authorized transmitter 123 is malfunctioning, or when its power source is exhausted. Yet in other applications switch 143 it is used to program controller 103.

In another embodiment the system employs a dedicated learn switch 151 in addition to switch 143, solely or redundantly serving the function of placing controller 103 into the learn mode. By activating learn switch 151 controller 103 automatically enters the learn mode and awaits a signal from one or more signals 127 from one or more transmitters 121. Upon receiving a signal 127, decoder 135 decodes signal 127 into an authorization code and a command code. In the learn mode, controller 103 stores the authorization code, thereby programming the authorization code of signal 127 from transmitter 121. In another embodiment controller 103 is programmed to enter into learn mode only through the activation of learn switch 151, leaving valet switch 143 for other functionality or eliminating it altogether.

From a practical perspective, switch 151 greatly simplifies the programming of new transmitters 121 into controller 103 by eliminating routines that heretofore were prerequisite steps to the activation of the learn mode. A user by activating switch 151 will send a signal, such as a pulse or change in voltage, to controller 103, which will in response optionally send an audio and/or a visual signal indicating that it is in the learn mode and allow the user to program additional authorization codes from transmitters 121, as described above.

In a commercial vehicle sales environment, the security systems 101 are preloaded on the inventory. The installer could choose to place switch 151 at the same general vicinity of the vehicle in each of the vehicles on the lot. One example of that is to place switch 151 next to the battery of the vehicle. It is understood, however that any location could be chosen. This will allow any attendant or lot personnel such as a salesperson to readily locate switch 151 and program new transmitters 121. In another embodiment learn switch 151 is configured integral to controller 103. This allows the users to locate and activate switch 151 by knowing where controller 103 is installed, which is commonly at the computer or relay box of the vehicle. Yet in another embodiment switch 151 is connected or coupled to controller 103 a close proximity or short distance therefrom. In another embodiment, switch 151 is conspicuous, for ease of location and identification. Switch 151 could for example have an orange or yellow sticker or tag providing visual, conspicuous identification to the lot personnel (such sticker or tag could be permanent or removable). Common to all of these embodiments is an environment/functionality where the personnel do not have to be familiar with the programming sequences of controller 103. Instead, they know where to look for and activate switch 151, which essentially acts as direct access to the activation of the learn mode of controller 103 and therefore allows the personnel to program one or more transmitters 121.

Although relay 139, visual indicator 141, override switch 143, learn mode switch 151, sensor(s) 147, and shock sensor 145 are illustrated having dedicated input to controller 103, these units and other units coupled to controller 103 could be coupled through a bus now employed in a number of vehicles. This bus has a predetermined protocol and it allows the vehicle manufacturer to apply a number of electrical units without having to install dedicated harnesses to control them. This is a cost, power and weight savings, as well as a way to reduce a number of parts, thus increasing the reliability.

While the present invention has been described herein with reference to particular embodiments thereof, a degree of latitude or modification, various changes and substitutions are intended in the foregoing disclosure. It will be appreciated that in some instances some features of the invention will be employed without corresponding use of other features without departing from the spirit and scope of the invention as set forth.

1. A controller configured to respond to at least one transmitter, the controller comprising: at least one learn switch, wherein the controller is configured to respond to at least one activation of said learn switch, thereby entering a learn mode, and wherein in said learn mode said controller is configured to retain an authorization code transmitted to said controller by said transmitter.

2. The controller of claim 1 wherein said controller is configured to replace at least one OEM operational relay.

3. The controller of claim 1 further comprising a relay connected to said controller, wherein said relay is configured to replace an OEM operational relay.

4. The controller of claim 1 further comprising a relay connected to said controller, wherein said relay is connected in series with an OEM cutoff relay.

5. The controller of claim I wherein said learn switch is integral to said controller.

6. The controller of claim 1 wherein said learn switch is located in close proximity to said controller.

7. The controller of claim I wherein said learn switch is conspicuously placed in a vehicle allowing lot personnel to locate said learn switch.

8. The controller of claim I wherein said learn switch is located in a designated area of a vehicle in a lot of vehicles.

9. A system comprising a controller and at least one transmitter, the controller comprising a learn switch, wherein said controller responds to at least one activation of said learn switch thereby placing said controller in a learn mode, wherein said controller is configured to decode and store an authorization code of a signal transmitted to said controller by said transmitter.

10. The controller of claim 9 wherein said controller is configured to replace an OEM operational relay.

11. The controller of claim 9 further comprising a relay switch connected to said controller, wherein said relay switch is configured to replace an OEM operational relay.

12. The controller of claim 9 further comprising a relay connected to said controller, wherein said relay is connected in series with an OEM operational relay.

13. The controller of claim 9 wherein said learn switch is integral to said controller.

14. The controller of claim 9 wherein said learn switch is located in close proximity to said controller.

15. The controller of claim 9 wherein said learn switch is conspicuously placed in a vehicle allowing lot personnel to locate said learn switch.

16. The controller of claim 9 wherein said learn switch is located in a designated area of a vehicle in a lot of vehicles.

17. Controller means for controlling security and convenience functionality of a vehicle comprising a dedicated learn switch means for placing said controller means in a learn mode, wherein said controller means is configured to decode and store an authorization code of a signal transmitted to said controller means by a transmitter means.

18. The controller means of claim 17 wherein said controller means is configured to replace an OEM cutoff relay.

19. The controller means of claim 17 further comprising a relay switch means for disabling the nominal operation of a vehicle, wherein said relay switch means is configured to replace an OEM operational relay.

20. The controller means of claim 17 further comprising a relay means connected to said controller, wherein said relay means is connected in series with an OEM operational relay and said relay means is configured to operate in series with said OEM operational relay.

21. The controller of claim 17 wherein said learn switch means is integral to said controller means.

22. The controller means of claim 17 wherein said learn switch means is conspicuously located in proximity to said controller means.

23. A method of placing a controller in a vehicle security system into a learn mode, said method comprising activating a dedicated learn switch, whereby said controller enters said learn mode and is configured to receive at least one signal from a transmitter, said signal comprising at least an authorization code; retaining said authorization code in a memory and responding to subsequent signals comprising said authorization code.
